(19) United States
(12) Patent Application Publication
(10) Pub. No.: US 2008/0269927 A1
(43) Pub. Date: Oct. 30, 2008

(54) PLAYBACK OF AUDIO INFORMATION THROUGH A WIRELESS DOCKING STATION

(76) Inventors: Thomas H. Szolyga, Saratoga, CA (US); Trentent Tye, Calgary (CA)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/742,584

(22) Filed: Apr. 30, 2007

(51) Int. Cl. G06F 17/00

(52) U.S. Cl. 700/94

(57) ABSTRACT

A portable electronic device comprises a wireless transceiver and logic coupled to the antenna. The logic is adapted to cause audio information to be transmitted through the wireless transceiver to a wireless docking station for playback by the wireless docking station.

### BACKGROUND

A multitude of various types of media players are available. Using such devices, users can listen to various types of audio information such as music, podcasts, etc. A user may listen to a portable media player using headphones. If the user desires to playback audio from the portable media player via a separate playback, the user connects the portable media player to the playback device via an electrical cable. The wired connection between the media player and the playback device can be burdensome to the user.

### BRIEF DESCRIPTION OF THE DRAWINGS

For a detailed description of exemplary embodiments of the invention, reference will now be made to the accompanying drawings in which:

FIG. 1 shows a system comprising a portable electronics device wirelessly coupled to a wireless docking station in accordance with various embodiments;

FIG. 2 shows a block diagram of the wireless docking station of FIG. 1 in accordance with various embodiments;

FIG. 3 shows a block diagram of the portable electronics device of FIG. 1 in accordance with various embodiments; and

FIG. 4 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The term “system” refers to a combination of two or more components. A system may comprise, for example, the combination of a server and a client communicatively coupled thereto, or a server alone, a client alone, or a subsystem within a computer.

### DETAILED DESCRIPTION

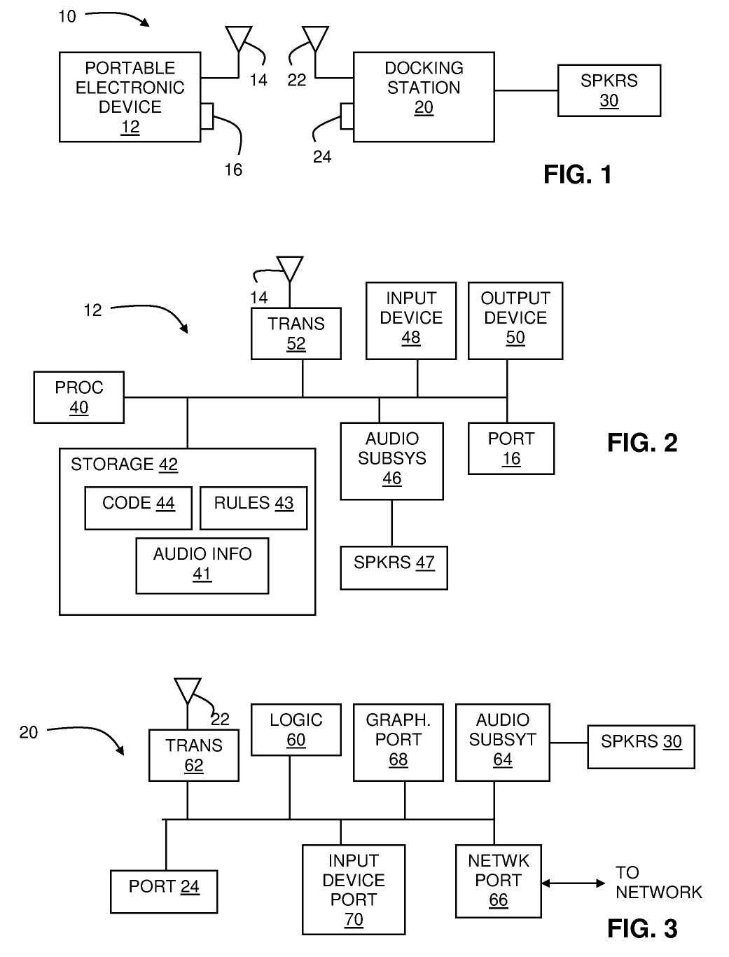

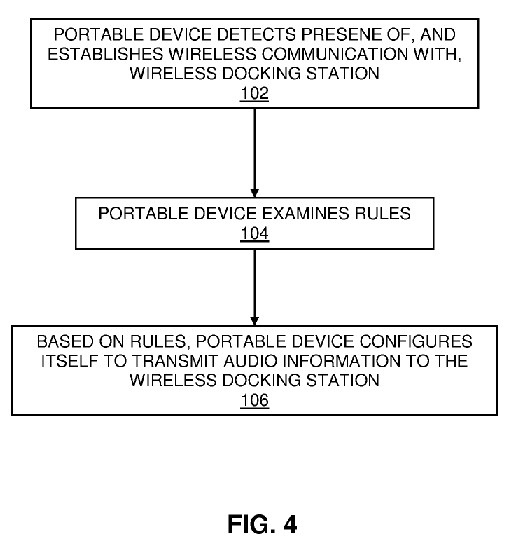

FIG. 1 shows a system 10 comprising a portable electronic device 12 wirelessly coupled to a wireless docking station 20. The wireless docking station 20 comprises or couples to one or more speakers 30. In accordance with various embodiments, the portable electronic device 12 wirelessly transmits audio information from an antenna 14 to an antenna 22 of the wireless docking station 20 for playback on speakers 30. In various embodiments, the audio information comprises music or other types of audio content.

The wireless communication link between the portable electronic device 12 and the wireless docking station 20 comprises a radio frequency (RF) link or an infra-red (IR) link. In some embodiments, the wireless communication link comports with the IEEE 802.11 family of wireless standards, the Bluetooth standard, or any other suitable wireless standard.

The portable electronic device 12 also comprises a port 16 (sometimes referred to herein as a “wireless docking station port”). Similarly, the wireless docking station 20 comprises a port 24 (sometimes referred to herein as a “portable electronic device port”). In some embodiments, the ports 16 and 24 comprise electrical connectors. The portable electronic device 12 can be mated to (“docked”) to the wireless docking station 20. When docked, the electrical connectors 16 and 24 are connected together establishing data connectivity between portable electronic device 12 and the wireless docking station 20. In some embodiments, the connectors 16 and 24 are directly connected together, while in other embodiments, the connectors 16 and 24 are connected together via an electrical cable. When docked, the data connectivity between the portable electronic device 12 and the wireless docking station 20 enables the user of the portable electronic device 12 to access and use other devices and resources provided in, or accessible to, the wireless docking station 20.

FIG. 2 illustrates an embodiment of the portable electronic device 12. In at least some embodiments, the portable electronic device 12 comprises a notebook computer. As shown, the device 12 comprises a processor 40 coupled to the port 16 (to which the wireless docking station 20 can be connected), storage 42, an audio subsystem 46, an input device 48, an output device 50 and a wireless transceiver 52. The processor 40 executed code 44 stored on storage 42. The processor 40 executing code 44 comprises logic that enables some or all of the functionality described herein for the portable electronic device 12. Storage 42 comprises a computer-readable medium that comprises volatile memory (e.g., random access memory), non-volatile storage (e.g., hard disk drive, Flash memory, etc.), or combinations thereof. The audio subsystem 46 comprises an amplifier, filter, and/or other types of audio electronics for driving one or more speakers 47. Speakers 47 are built-in to the portable electronic device 12 in at least some embodiments. The input device 48 comprises one or more of a keyboard, mouse, or other type of pointing device. The output device 50 comprises a display (e.g., a liquid crystal display). The wireless transceiver 52, to which the antenna 16 couples, enables one or two-way wireless communications with the wireless docking station 20.

FIG. 3 illustrates an embodiment of the wireless docking station 20. As shown, the wireless docking station 20 comprises logic 60 coupled to port 24 (to which the portable electronic device 12 can be connected), a wireless transceiver 62 (to which antenna 22 couples), an audio subsystem 64, a network port 66, a graphics port 68, and an input device port 70. In some embodiments, the logic 60 comprises a processor that executes code to provide the wireless docking station 20 with some or all of the functionality described herein. To the extent the logic 60 comprises code, such code is stored on a computer-readable medium that comprises, volatile memory (e.g., random access memory), non-volatile storage (e.g., hard disk drive, Flash memory, etc.), and combinations thereof. The wireless transceiver 60, to which the antenna 22 couples, enables one or two-way wireless communications with the portable electronic device 12.

Referring still to FIG. 3, the audio subsystem 64 comprises an amplifier, filter, and/or other types of audio electronics for driving one or more speakers 30. Speakers 30 may be built-in to the wireless docking station 20 in at least some embodiments, while in other embodiments, the speakers are separate from and connected to a housing of the wireless docking station 20. The network port 66 is usable to connect the wireless docking station 20 to a network link such as Ethernet for communication with a local area network (LAN) and/or a wide area network (WAN). The graphics port 68 is usable for connection to a graphics display. The input device port 70 is usable for connection to an input device such as a keyboard, a mouse, or other type of pointing device

When the portable electronic device 12 is docked to the wireless docking station 20 (i.e., electrical connectivity between connectors 16 and 24 is established), a user of the portable electronic device 12 can use one or more of the resources provided by the wireless docking station. For example, a user can use an input device connected to input device port 70 and a display connected to graphics port 68 in addition to or, instead of, the input device 48 and output device 50 of the portable electronic device 12. By way of a further example, a user of the portable electronic device 12 can access a network via the wireless docking station's network port 66.

Referring to FIGS. 1-3, in accordance with various embodiments of the invention, audio information stored in, or otherwise accessible to, the portable electronic device 12 is wirelessly transmitted to the docking station 20 via antennas 14 and 22 when wireless communication has been established between the portable electronic device 12 and the wireless docking station 20. In some embodiments, the audio information is stored on the portable electronic device's storage 42 (audio information 41, FIG. 2).

The storage 42 of the portable electronic device 12 (FIG. 2) comprises audio information 41 (which can be wirelessly transmitted to the docking station 20 for playback thereon) and rules 43. The rules 43 are usable-configurable. Using input device 48 and output device 50, a user can create and/or edit the rules as desired to implement an audio information playback experience of the user's choosing. The rules 43 may be set to a default state that can then be changed by the user as desired. When the portable electronic device 12 is within wireless communication range of the wireless docking station 20, the rules 43 specify whether the audio information 41, to the extent that the user activates the portable electronic device 12 to play the audio information at all, is played through only speakers 47 of the portable electronic device 12, only through speakers 30 of the wireless docking station 20, or both.

FIG. 3 illustrates a method in accordance with various embodiments of the invention. At 102, a user brings the portable electronic device 12 close enough to the wireless docking station 20 so as to enable the portable electronic device to detect the presence of, and establish wireless communication with, the wireless docking station. In some embodiments, the detection by the portable electronic device of the docking station is automatic (i.e., without human involvement other than bringing the portable device sufficiently near the docking station). The detection of the wireless docking station 20 can be performed in accordance with any suitable technique and, in some embodiments, is based on the wireless protocol implemented for the wireless communication link between the portable electronic device 12 and wireless docking station 20.

At 104, the portable electronic device 12 examines the rules 43 to determine the playback preferences specified by the rules. At 106, based on the rules 43, the portable electronic device configures itself to transmit the audio information 41 to the wireless docking station. That is, if the rules 43 specify that playback of the audio information 41 is to be through the speakers 30 of the wireless docking station 20, the portable electronic device 12 wirelessly transmits the audio information to the wireless docking station 20. The portable electronic device 12 also disables its own audio subsystem 46 if so specified by rules 43. In other embodiments, the rules 43 may specify that the portable electronic device's audio subsystem 46 is to remain enabled to also play the audio information through portable electronic device's speakers 47 in addition to the wireless docking station's speakers 30.

The rules 43 alternatively may specify that, even though wireless communication with the wireless docking station 20 has been detected, the audio information 41 is not to be transmitted to the wireless docking station 20.

In some embodiments, the wireless docking station 20 wirelessly receives the audio information 41 from the portable electronic device 12 (if the rules 47 so permit) when the portable electronic device 12 is not electrically connected to the docking station 20 via connectors 16 and 24. In other embodiments, the wireless docking station 20 wirelessly receives the audio information 41 from the portable electronic device 12 (rules 47 permitting) even when the portable electronic device 12 is electrically connected to the docking station 20 via connectors 16 and 24.

In various embodiments, if the portable electronic device 12 is removed from the vicinity of the wireless docking station such that the wireless communication is broken, the portable electronic ceases transmitting the audio information to the wireless docking station.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A portable electronic device, comprising:
a wireless transceiver; and
logic coupled to said antenna;
wherein said logic is adapted to cause audio information to be transmitted through said wireless transceiver to a wireless docking station for playback by the wireless docking station.

2. The portable electronic device of claim 1 further comprising speakers and wherein said logic disables playback of said audio information through said speakers when transmitting said audio information to the wireless docking station

3. The portable electronic device of claim 1 further comprising a rule that specifies whether a speaker of said portable electronic device is to play audio information or whether said wireless docking station is to receive said audio information.

4. The portable electronic device of claim 1 further comprising a rule that, based on whether the logic detects the wireless docking station, specifies whether a speaker of said portable electronic device is to play audio information or whether said wireless docking station is to receive said audio information.

5. The portable electronic device of claim 1 wherein, when said logic automatically detects that wireless communication with said wireless docking station has ceased, said logic ceases causing the audio information to be transmitted.

6. The portable electronic device of claim 1 further comprising a port coupled to said logic, said docking station port providing data communication between said logic and said docking station.

7. The portable electronic device of claim 1 further comprising a display that enables a user to configure a rule that specifies whether a speaker of said portable electronic device is to play audio information or whether said wireless docking station is to receive said audio information

8. The portable electronic device of claim 1 wherein the audio information comprises music.

9. A wireless docking station, comprising:
a speaker;
a wireless transceiver; and
a network port adapted to be coupled to a wired network, said network port, wireless transceiver speaker are coupled together;
wherein said wireless transceiver receives audio information from an electronic device for playback through said speaker.

10. The wireless docking station of claim 9 further comprising a portable device port to which said portable device can be connected.

11. The wireless docking station of claim 10 wherein said wireless transceiver receives said audio information even when said portable device is not connected to said portable device port.

12. The wireless docking station of claim 9 wherein said wireless transceiver receives said audio information from a portable computer.

13. The wireless docking station of claim 9 wherein said wireless transceiver receives said audio information even when said portable device is not electrically connected to the wireless docking station.

14. A method, comprising:
detecting a wireless docking station; and
configuring a portable electronic device to transmit audio information to said wireless docking station.

15. The method of claim 14 wherein configuring the portable electronic device comprises configuring an audio capability of the portable electronic device based on a rule associated with the wireless docking station.

16. The method of claim 14 further comprising examining a rule in said portable electronic device, said rule associated with the wireless docking station.

17. The method of claim 14 wherein configuring the portable electronic device comprises disabling an audio playback capability of the portable electronic device.

18. The method of claim 14 wherein configuring the portable electronic device comprises disabling an audio playback capability of the portable electronic device upon detecting the wireless docking station.

19. The method of claim 18 further comprising enabling the audio playback capability of the portable electronic device upon cessation of wireless communication between the portable electronic device and the wireless docking station.

20. The method of claim 18 further comprising configuring the portable electronic device to cease transmitting the audio information upon cessation of wireless communication between the portable electronic device and the wireless docking station.
